(19) United States
(12) Patent Application Publication
(10) Pub. No.: US 2021/0322807 A1
(43) Pub. Date: Oct. 21, 2021

(54) Electronic Detection Extinguisher System

(71) Applicant: John P. Baker, Webster, NY (US)

(72) Inventor: John P. Baker, Webster, NY (US)

(21) Appl. No.: 16/852,319

(22) Filed: Apr. 17, 2020

(51) Int. Cl. A62C 3/07; A62C 99/00

(52) U.S. Cl. CPC A62C 3/07; A62C 99/0063; A62C 99/0027

(57) ABSTRACT

An electronic detection extinguisher system detects and extinguishes a fire which starts at the interaction of a fuel nozzle and the fuel inlet. The electronic detection extinguisher system is comprised of at least one controller which detects and sends signals, at least one sensor which sends signals to the encoder, at least one encoder which extends the signals provided by the controller or the sensor, at least one valve which is electronically controlled that releases the extinguisher solution or gas, at least one relay which provides direct current from the power supply to the electronically controlled valve, at least one relay which cuts the direct current of the fuel pump which stops the fuel from pumping, at least one extinguisher line which provides the gas or extinguisher solution to the tip of the extinguisher, at least one data cable which connects the encoder to the sensor, at least one source of extinguishing solution or gas, at least one regulator to regulate the pressure of the gas or extinguisher solution.

### TECHNICAL FIELD

This disclosure relates generally to fuel pumps, and more particularly, to fire extinguishers used when a fire occurs at the pump.

### BACKGROUND

Known fuel pumps provide fuel to multiple different forms of fuel tanks. A fuel pump is typically inserted into the fuel tank in the form of a nozzle. During the fueling process fires can occur. Some fuel pumps have automatic fire extinguishers located on the ceiling, some have manual fire extinguishers located on the side of the pump, and some have no fire extinguishers at all.

Fires that occur at the interaction of the fuel nozzle and fuel inlet are not only the most common, but are typically the most challenging fires to prevent, and because of this the fires can become uncontrollable when they occur. This is a result of the current extinguisher designs being too far away from the spot of the fire. Typically, extinguishers are normally located in the range of 5 feet to 15 feet away from the fuel nozzle and fuel inlet interaction. Among other things, the new system solves the distance problem.

### SUMMARY

A new electronic detection extinguisher system detects and extinguishes a fire which starts at the interaction of a fuel nozzle and the fuel inlet. The electronic detection extinguisher system is comprised of at least one microcontroller which detects and sends signals, at least one sensor which sends signals to the encoder, at least one encoder which extends the signals provided by the microcontroller and/or the sensor, at least one valve which is controlled so that it releases an extinguisher solution or inert gas, at least one relay which provides direct current from the power supply to the controlled valve, at least one relay able to cut the direct current of the fuel pump which when cut stops the fuel from pumping, at least one line which provides an extinguisher solution or inert gas to the tip of the extinguisher, at least one data cable which connects the encoder to the sensor, at least one source of extinguishing solution or inert gas, at least one regulator to regulate the pressure of the inert gas or extinguisher solution, at least one led, a speaker, and an LCD screen to notify issues or provide reports and updates on whether the extinguisher is working correctly.

### BRIEF DESCRIPTION OF THE DRAWINGS

The foregoing aspects and other features of a fire extinguisher that electronically detects and extinguishes fires.

FIG. 1 is a schematic diagram of an electronic detection extinguisher system that is composed of a sensor, a guard, a sensor casing, a sensor cover, and a guard. The system is described as being capable of extinguishing a fire that occurs at a fuel pump.

FIG. 2 is a front view of the sensor 1′ in FIG. 1.

FIG. 3 is a side view of the entire pump assembly which includes the sensor 1′, the sensor casing 4′, the sensor cover 5′, the guard 2′, the data cable 21′, the extinguisher line 27′, the fuel line 28′, and the fuel pump 29′.

FIG. 4 shows the assembly from FIG. 3 being used to fuel an automobile 30.

FIG. 5 shows the assembly from FIG. 1 without the low pressure CO2 tank 6′

### DETAILED DESCRIPTION

For a general understanding of the present embodiments, references are made to the drawings. In the drawings, like reference numerals have been used throughout to designate like elements.

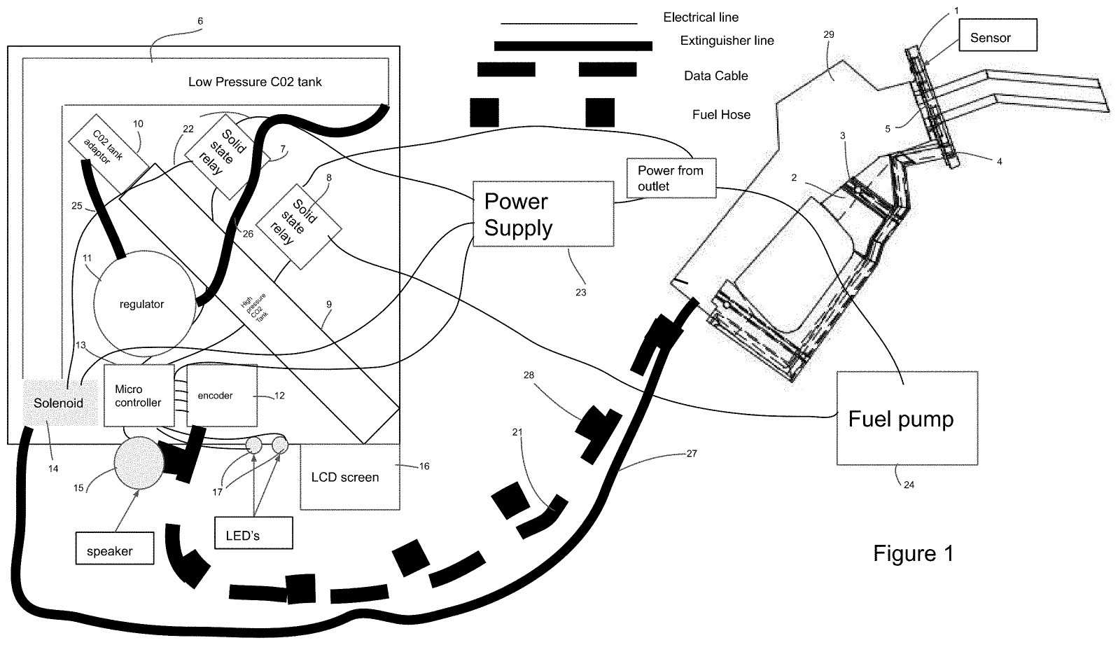

FIG. 1. depicts a block diagram of an electronic detection extinguisher system according to the present invention that is configured to be installed onto existing fuel pumps. The electronic detection extinguisher system includes a low pressure CO2 tank 6, a Fortek SSR-25 DD solid state relay 7, a Fortek SSR-25 DD solid state relay 8, a CO2 tank 9, a CO2 tank adaptor 10, a Taprite regulator 11, a PCA9615DPJ encoder 12 which converts i²C to differential i²C to allow for a sensor signal to be extended over long lengths of wire. The signal needs 6 wires to travel through these wires are; DSCLP—the differential positive clock line, DSCLM—the differential negative clock line, DSDAP—the differential positive data line, DSDAM—the differential negative data line, VDD—provides the positive voltage, and GRND—provides the ground to an Arduino Uno microcontroller 13, this wire arrangement could be changed or combined, a SNS 12V ½ in solenoid valve 14 which preferably has a max pressure of 150 psi because the valve could fail if a higher pressure is applied, a speaker 15, LCD screen 16, LED's 17, a guard cover 3, a guard 2, a sensor casing 4, a sensor backing 5, and a Melexis MLX90614 3V sensor 1. Where specific products names are called out that was the product used in the preferred fire suppression system/device. Any suitable product could be used in place of the specific one named. In some embodiments the guard and guard cover will be combined to be one part. The sensor casing and sensor backing can also be combined in the same part. encoder 12 and sensor 1 receive power from microcontroller 13 through data cable 21. Data cable 21 is preferably composed of 6 wires. The 6 wires that run through the data cable include the DSCLP, DSCLM, DSDAP, DSDAM, VCC, and the GRND wire. The 4 signals are used to communicate information from the sensor to the decoder and the two power wires [VCC and GRND] are used to power the sensor. Data cable 21 could be composed of a number of wires ranging from 1 to 100. it is also possible that the data cable could be turned into a wireless signal. When a difference is detected in the ambient temperature and the object temperature by sensor 1 that is greater than 30 degrees Fahrenheit a signal is sent from sensor 1 to encoder 12 and then to the microcontroller 13. 4 wires connect encoder 12 to microcontroller 13. These 4 wires include; SDA—data line, SCL—clock line, VCC—provides positive voltage, and GRND—provides ground and are different from the 6 wires described above. These 4 wires provide microcontroller 13 with a decoded signal from sensor 1. These 4 wires could be eliminated if microcontroller 13 were to be combined with encoder 12 or if the encoder was eliminated or if the signal was transmitted wirelessly between encoder 12 and microcontroller 13. Once microcontroller 13 receives the decoded signal from encoder 12 that there is a difference in temperature microcontroller 13 sends power to solid state relay 7 and solid-state relay 8. Solid state relay 7 closes the circuit 22 between 12-volt power supply 23 and solenoid valve 14. The 12 volts supplied to the solenoid valve opens the solenoid valve. When power is sent to solid state relay 8 the electricity of fuel pump 24 is cut off so that the fuel stops pumping. High pressure CO2 tank 9 is connected to regulator 11 with CO2 line 25 which is connected to CO2 tank adaptor 10 which is connected to high pressure CO2 tank 9. The regulator regulates the CO2 from 850 PSI (PSI—pounds per square inch) to 150 PSI CO2. Line 26 connects low pressure CO2 tank 6 to regulator 11. Low pressure CO2 tank 6 is connected to solenoid valve 14 which is connected to CO2 line 27 which is connected to guard 2. Guard 2 has a hole which is open to the air, and if solenoid valve 14 opens CO2 travels from low pressure CO2 tank 6, which is held at a constant 150 PSI, through CO2 line 27 and out guard 2 to extinguish the fire.

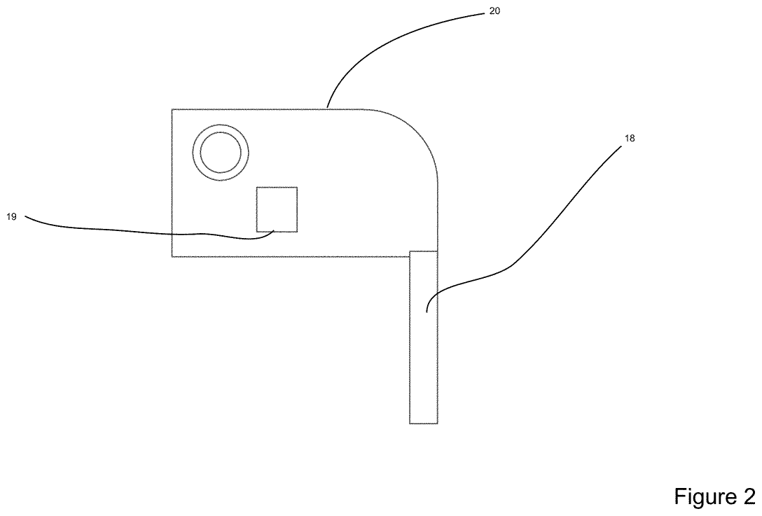

FIG. 2 shows the sensor assembly 1 referenced in FIG. 1. A sensor 1, a data cable 18, an extension circuit 19, and a waterproof case 20. The data cable is where the transmission between the microcontroller and the sensor occurs.

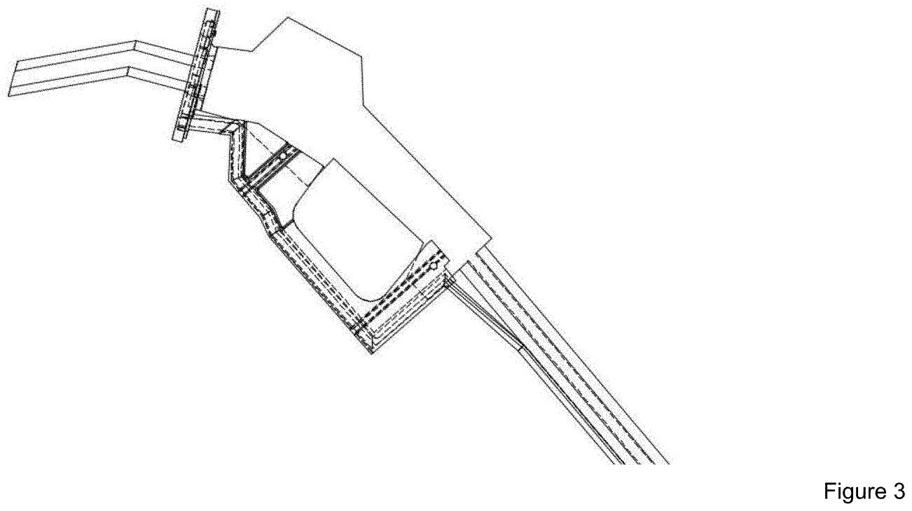

FIG. 3 provides a detailed view of an assembly composed of a sensor 1′, a sensor casing 4′, a sensor cover 5′, a guard 2′, a data cable 21′, an extinguisher line 27′, a fuel line 28′, and a fuel pump 29′. All of which components have been referenced in FIG. 1

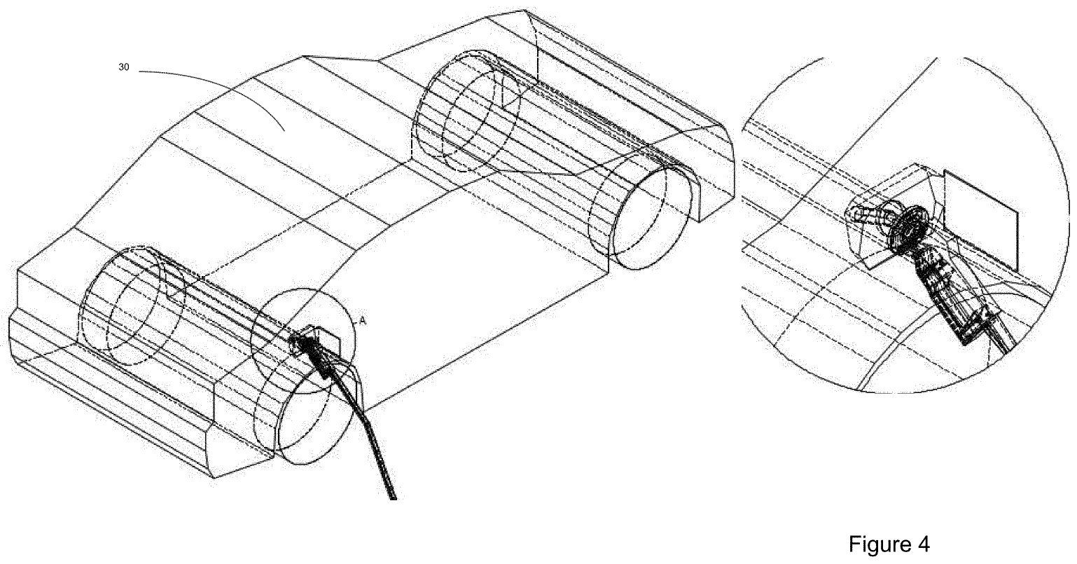

FIG. 4 provides a view of the assembly composed of a sensor 1′, a sensor casing 4′, a sensor cover 5′, a guard 2′, a data cable 21′, an extinguisher line 27′, a fuel line 28′, and a fuel pump 29′. All of which components have been referenced in FIG. 1. FIG. 4 gives a view of this assembly in the position to stop an automobile fueling thermal event. This position is a common place for the electronic detection extinguisher system, but is one of the many places that the electronic detection extinguisher system can be used.

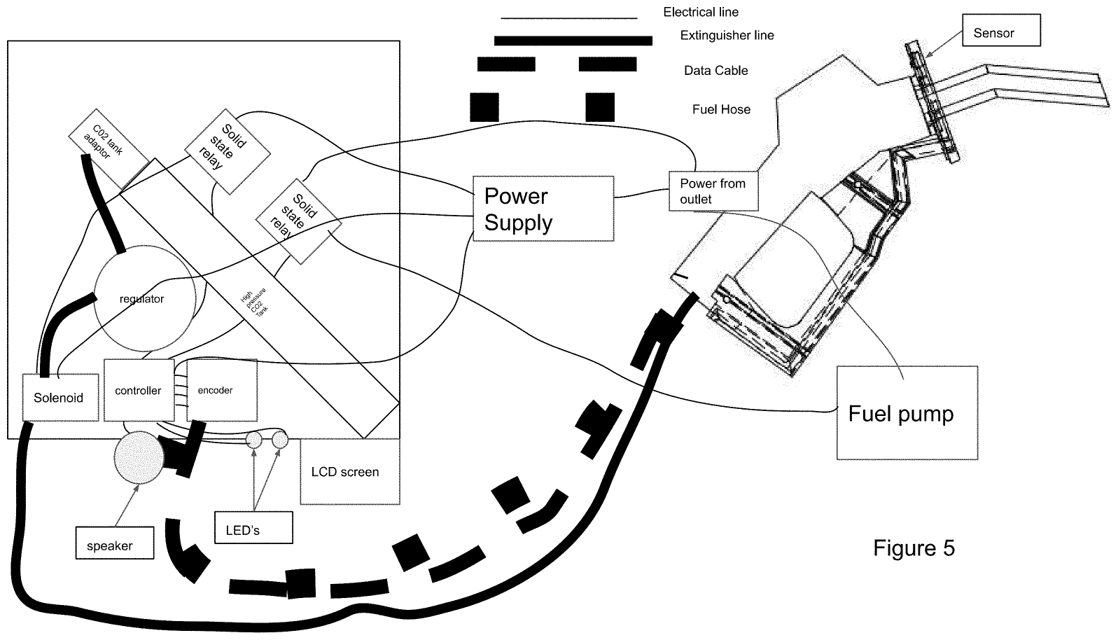

Building on the above, this invention could be done with one containment tank. This one containment tank variant is displayed in FIG. 5. Other configurations for the invention include: 2 containment tanks with the same pressure that is either high pressure or low pressure, a different inert gas or extinguisher materials which is not CO2 could be used to extinguish the fire, a threshold of temperature difference between the ambient temperature and the object temperature can range from 1 degree Fahrenheit to 10,000 degrees Fahrenheit, the pressure of CO2 can also range from 1 PSI to 5000 PSI, multiple sensors can be placed instead of the singular sensor being used on the current extinguisher, multiple or no CO2 or extinguisher lines can be included for a higher, less, or equal output of material or inert gas, multiple data wires or no data wires could be used to transmit data and power. multiple solenoid valve or no solenoid valve can be used to increase decrease or equal the amount of material or CO2 that is being output through the extinguisher, more or less than 1 relay or solid state relay can be used to increase or decrease the amount of electricity used in the circuits, Batteries can be used in place of the power supply which powers the circuit, a different voltage could be used to power the circuit, all of the materials building the extinguisher could be held in the guard and the entire extinguisher could be a self-contained unit with no power, data, or CO2 lines, the guard could be screwed together instead of being puzzle pieces, a valve could be placed on the end of the fuel nozzle that is mechanical for human operation, no microcontroller could be used in the operation, speakers LED's and speakers could be removed, a circuit with just an alarm could be used, a circuit where the fuel would be shut off with no other component of the extinguisher installed, the data or CO2 lines could be routed inside the fuel line or routed in different areas of the fuel station. A circuit could be used with no encoder or the encoder could be encoding a different type of signal. i²C or differential i²C could not be used to transmit the data of the sensor or microcontroller.

From reading the above there are obvious other ways that this electronic detection extinguisher system could work. The preferred method for operation is stated in [0020]-[0024]. Communicating from the microcontroller to the sensor using differential i²C, having 2 containment tanks having operating pressures of 850 PSI and 150 PSI using 12 volts of electricity to power a circuit which is all wired to the wall so that there is never a chance for the pump to pump fuel without it being protected by the electronic detection extinguisher system. a solenoid valve for quick operation and a microcontroller to control the relationships between the sensor and the releasing of the CO2.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

1. A fire suppression system comprising:
A tank holding a extinguisher solution or inert gas;
Said tank containing a valve;
A controller for detecting and sending signals;
Said controller connected to a sensor;
Said sensor for detecting temperature;
Said controller sending a signal when said temperature is detected by said sensor as being over a threshold;
Said signal is then sent by said controller to said valve causing said valve to open;
Said extinguisher solution or inert gas flowing through said valve to suppress the fire.

2. The system according to claim 1:
further including a encoder;
Whereby said encoder allows the range of said signal to be extended.

3. The system according to claim 1:
Further including a encoder;
a second encoder;
said signal is sent to said encoder in I2C form;
Said encoder changes said signal to DI2C and sends it to said second encoder;
Said second encoder changes the signal from DI2C to I2C;
Whereby said signal is sent to the sensor from a longer distance.

4. The system according to claim 1:
further including a encoder;
a second encoder;
said signal is sent to said encoder in I2C form;
Said encoder changes the signal to DI2C and sends it to said second encoder;
Said second encoder changes the signal from DI2C to I2C;
a decoder;
a data cable;
the data cable containing at least four wires.
Said wires providing at least four signals;
whereby said four signals communicate the data from said sensor to said decoder;

5. The system according to claim 1:
further including a high pressure tank;
said high pressure tank stores a large amount of said extinguisher solution or inert gas;

6. The system according to claim 1:
further including high pressure tank;
a regulator;
said regulator lowers the pressure of said extinguisher solution or inert gas producing a regulated extinguisher solution or inert gas;
a second tank;
whereby the regulated extinguisher solution or inert gas is stored in said second tank;

7. The system according to claim 1:
further including a low pressure tank;
a regulator;
said regulator lowers the pressure of said extinguisher solution or inert gas producing a regulated extinguisher solution or inert gas;
said low pressure tank stores said regulated extinguisher solution or inert gas;
whereby said regulated extinguisher solution or inert gas is at a low enough pressure for the valve;

8. The system according to claim 1:
further including a relay;
said relay has low current power applied to it from said controller;
said relay switching on high current power in response to said temperature being over said threshold;
whereby once said signal is sent from said controller to said relay to open said valve said relay switches on high current power to open said valve and extinguish the fire;

9. The system according to claim 1:
further including further including a low pressure tank;
a regulator;
a relay;
said valve prevents said extinguisher solution or inert gas from releasing unless an electrical current is applied to it;
said relay applies current to said valve;
whereby said valve releases said regulated extinguisher solution or inert gas from the low pressure tank;

10. The system according to claim 1:
wherein said controller is a microcontroller;

11. The system according to claim 1:
wherein said extinguisher solution or inert gas is carbon dioxide;

12. A method of fire suppression comprising:
detecting when a temperature is over a predefined threshold by use of a sensor;
sending a signal from said sensor to an encoder;
encoding said signal for transmission over longer ranges when said temperature is over said threshold;
opening said valve in response to said signal;
flowing an extinguisher solution or inert gas through said valve when open.

13. The method of claim 12 further including;
extending the range of said signal from said sensor by use of a data cable.

14. The method of claim 12 further including:
extending the range of said signal from said sensor by use of a data cable;
providing a low pressure tank;
containing said extinguisher solution or inert gas in said low pressure tank;
regulating the pressure of said extinguisher solution or inert gas in said low pressure tank;
flowing an extinguisher solution or inert gas from said low pressure tank through said valve when open.

15. The method of claim 12 further including:
extending the range of said signal from said sensor by use of a data cable;
providing a high pressure tank;
providing a low pressure tank;
containing said extinguisher solution or inert gas in said high pressure tanks;
regulating the pressure of said extinguisher solution or inert gas in said high pressure tank;
producing a regulated extinguisher solution or inert gas in response to the regulation;
transferring said regulated extinguisher solution or inert gas to said low pressure tank;
flowing an extinguisher solution or inert gas from said low pressure tank through said valve when open.

16. The method of claim 12 further including;
using carbon dioxide as the extinguisher solution or inert gas.

17. A fire suppression device comprising:
a microcontroller for detecting and sending signals;
said microcontroller connected to a sensor;
said sensor for detecting infrared radiation;
said microcontroller sending a signal when said infrared radiation is detected to by said sensor as being over a threshold;
Said signal is sent by said micro controller to a valve that opens to suppress the fire.

18. The device according to claim 17:
further including an encoder;
whereby said encoder allows the range of said signal to be extended.

19. The device according to claim 17:
further including a encoder;
a second encoder;
said signal is sent to said encoder in I2C form;
said encoder changes the signal to DI2C and sends it to said second encoder;
said second encoder changes the signal from DI2C to I2C whereby said signal is sent to the sensor from a longer distance.

20. The system according to claim 17:
further including a encoder;
a second encoder;
said signal is sent to said encoder in I2C form;
said encoder changes the signal to DI2C and sends it to said second encoder;
said second encoder changes the signal from DI2C to I2C a decoder;
a data cable;
the data cable containing at least four wires.
said wires providing at least four signals;
whereby the four signals communicate the data from the sensor to the decoder;

21. The device according to claim 17:
further including high pressure tank;
a regulator;
said regulator lowers the pressure of a extinguisher solution or inert gas to produce a regulated extinguisher solution or inert gas;
a second tank;
whereby the regulated extinguisher solution or inert gas is stored in said second tank
